(19) United States
(12) Patent Application Publication
(10) Pub. No.: US 2020/0257247 A1
(43) Pub. Date: Aug. 13, 2020

(54) TIMEPIECE MOVEMENT

(71) Applicants: Stephen FORSEY, Les Brenets (CH); Francois Trifoni, Le Lode (CH); Francois Trifroni, Le Locle (CH); David Bernard, Saint-Aubin (CH)

(72) Inventors: Stephen FORSEY, Les Brenets (CH); Francois Trifoni, Le Lode (CH); Francois Trifroni, Le Locle (CH); David Bernard, Saint-Aubin (CH)

(21) Appl. No.: 15/776,362

(22) PCT Filed: Nov. 11, 2016
(86) PCT No.: PCT/EP2016/077394

§ 371 Date: May 15, 2018

(51) Int. Cl. G04B 19/02

(52) U.S. Cl. CPC G04B 19/02

(57) ABSTRACT

Horology movement comprising:—at least one drive member; four regulating systems, each being kinematically connected with the said drive member via a drive kinematic network designed to transmit energy from the drive member to the said regulating systems; in which the said drive kinematic network comprises: a first differential gear set having an input kinematically connected to the drive member and having two outputs; a second and a third differential gear set each having an input kinematically connected to a respective output (5s) of the first differential gear set and each having two outputs, each of the latter outputs being kinematically connected to a respective regulating system; the said movement further comprising: an hours and minutes display device designed to be driven by the first differential gear set; at least one seconds display device designed to be driven by at least one of the second and third differential gear sets via a kinematic connection which branches off the said drive kinematic network, the said seconds display device comprising a seconds indicating member rotating as one with a mobile that meshes directly or indirectly with a mobile that the said drive kinematic network comprises

### TECHNICAL FIELD

The present invention relates to the field of horology. It more particularly relates to a timepiece movement comprising a plurality of regulating systems.

### BACKGROUND OF THE INVENTION

Document EP 1,706,796 describes a timepiece movement comprising two tourbillons connected to a shared motor organ via a differential gear. This differential gear allows the tourbillon cages to rotate independently of one another, and serves to average their running. The wheels of the going train therefore rotate at angular speeds in function of the average of the running of the two tourbillons, which serves to improve the precision of the running of the movement.

However, the motion-work is arranged conventionally relative to the going train, which imposes limitations on the freedom of the horologist to optimize the transmission of torque and to choose the rotation speeds of the wheels, tourbillons, etc.

Document WO 2013/104982 discloses a timepiece comprising four regulating organs, driven by a motor organ via a kinematic motive network comprising a plurality of differential gears. However, neither this arrangement nor the “Quatuor” piece by Roger Dubuis that implements it, comprises means for indicating seconds. The obvious solution to indicate the seconds would be to integrate an appropriate display organ into the motive network, in particular secured in rotation with one of the four seconds wheels comprised by the mechanism. However, this solution would be very limited in terms of the possibilities for the spatial arrangement of the seconds wheels in the movement. Indeed, there are only four positions present that do not require substantial changes to the construction of the movement.

The aim of the invention is therefore to propose a timepiece in which the aforementioned drawbacks are at least partially resolved.

### BRIEF DESCRIPTION OF THE INVENTION

More specifically, the invention relates to a timepiece movement comprising:
at least one motor organ, such as one or several motor organs stored in one or several barrels;
four regulating systems of any type(s), each being kinematically connected with said motor organ via a kinematic motive network arranged to transmit energy from the motor organ to each of said regulating systems such that it is possible to trace a kinematic link transmitting energy between the motor organ and each of the regulating systems.

More specifically, the kinematic motive network comprises:
a first differential gear having an input kinematically linked with the motor organ and having two outputs;
a second and third differential gear each having an input kinematically linked with a respective output of the first differential gear and each having two outputs. Each of the outputs of the second and third differential gears is kinematically linked with a respective regulating system.

The movement further comprises:
a device for displaying hours and minutes arranged to be driven by the first differential gear, either directly or indirectly;
at least one device for displaying seconds arranged to be driven by at least one of the second and third differential gears via a kinematic link branched off of said kinematic motive network, i.e., by a kinematic link that is not part of the kinematic motive network, said device for displaying seconds comprising a seconds display organ secured in rotation with a wheel that meshes directly or indirectly with a wheel comprised by said kinematic motive network, which thus constitutes said kinematic link. This wheel carrying the seconds display organ is therefore not part of said network by definition, and is therefore separate from the latter. In other words, this branched kinematic link does not participate in transmitting energy from the barrel to the regulating systems, but has a force takeoff on at least one of said differential gears, or on any intermediate wheel comprised by said network.

Consequently, the running of the four regulating systems is averaged in order to provide the display of the hour and, by arranging the display of the hours and minutes in order to be driven by the first differential gear while the display of the seconds is driven by a branch off of the kinematic motive network while having a force takeoff at the second and/or third differential gear, the movement can be optimized in particular in the torque transmission, and/or the rotation speeds of the various elements can be chosen relatively freely. Furthermore, the position of the display organ can also be chosen relatively freely, since it is no longer related to the position of the seconds wheels of the kinematic motive network. Indeed, a wheel meshing directly or indirectly with the kinematic motive network can be placed in the movement based on the constructor's needs, without having to make other changes.

Advantageously, the device for displaying hours and minutes is arranged to be driven directly by an element of the first differential gear, for example by driving a motion-work via the wheel serving as input for the first differential gear. Alternatively, an organ for displaying minutes can be secured in rotation with such a wheel, the organ for displaying hours being driven conventionally via a reducing gear.

Advantageously, the device for displaying seconds comprises an organ for indicating seconds arranged to be driven by an element from one of the second and third differential gears, such as a wheel serving as input for the corresponding differential gear.

Advantageously, the movement comprises two devices for displaying seconds, one of which is arranged to be driven by an element of the second differential gear, the other of which is arranged to be driven by an element of the third differential gear.

Advantageously, the device for displaying seconds is arranged to be driven by each of the second and third differential gears via a fourth differential gear. The indication of the seconds is therefore provided as a function of the average of the running of the four regulating systems, and greater production freedom is given to the horologist in terms of the rotation speeds of the various components.

Advantageously, the device for displaying seconds is integrated into said fourth differential gear, or is secured in rotation with one of its elements.

Advantageously, at least one of said differential gears comprises a constant force system, which limits variations in the torque transmitted to the regulating systems, and therefore serves to improve the isochronism of the movement.

### BRIEF DESCRIPTION OF THE DRAWINGS

Other details of the invention will appear more clearly upon reading the following description, made in reference to the appended drawings, in which:

FIG. 1 is a schematic illustration of a first embodiment of a movement according to the invention; and

FIG. 2 is a schematic illustration of a second embodiment of a movement according to the invention.

### DETAILED DESCRIPTION OF THE INVENTION

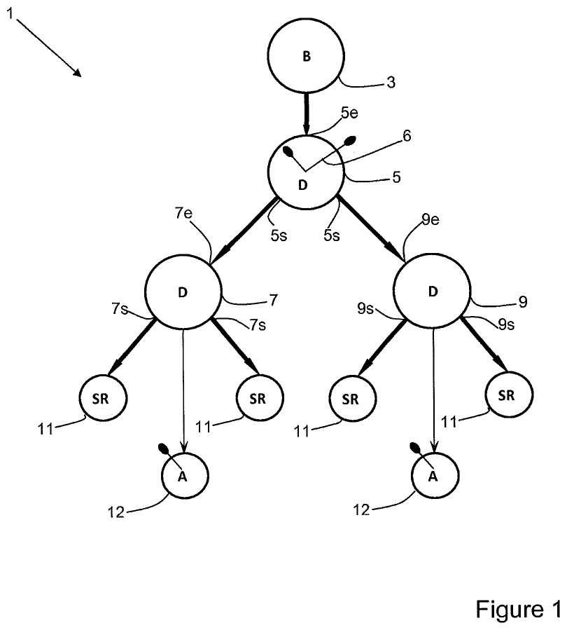

FIG. 1 schematically shows one embodiment of a timepiece movement 1 according to the invention.

The movement 1 comprises a motor organ 3, which may for example be one or several motor springs stored in one or several barrels in series and/or in parallel.

The motor organ 3 is kinematically linked with an input 5e of a first differential gear 5 formed by appropriate wheels. This differential gear 5 can be of any type, for example a spherical type, a flat type or any other configuration. The differential gear 5 as defined in the present invention comprises an input 5e and two outputs 5s. The mechanical link between the input 5e and the outputs 5s can be effected in any typical manner, for example via one or several satellite pinions, one or several resilient elements or any mechanism allowing a function equivalent to these latter. It may also comprise at least one constant force differential as described in document EP 2,548,084, herewith incorporated by reference in its entirety. This or these constant force device(s) may be found at the level of the differential(s), but also between the differential(s) and the regulating system(s).

The first differential gear 5 directly or indirectly drives a device for displaying hours and minutes 6, from one of its constituent elements. The device for displaying hours and minutes 6 may comprise organs for displaying hours and minutes, for example one or several hands, discs, rotary scales, bands or the like.

In order to drive the device for displaying hours and minutes 6, one of the wheels forming the differential gear, for example the wheel serving as input 5e, can drive a motion-work, or alternatively one of the wheels can be arranged to rotate at a rate of one revolution per hour, the organ for displaying minutes (a hand, disc, band or the like) being secured in rotation therewith, and the organ for displaying hours being driven conventionally via a reducing gear.

The two outputs 5s of the differential gear 5 each provide energy to the respective input 7e, 9e of a second differential gear 7, and a third differential gear 9, formed of appropriate wheels. The second and third differential gears also each comprise two outputs 7s, 9s, respectively, each of these outputs 7s, 9s being directly or indirectly kinematically linked with a respective regulating system 11. The same comments relative to the type of differential gear made relative to the first differential gear 5 also apply to the second and third differential gears 7, 9.

The network of differential gears 5, 7, 9, and of any intermediate wheels, not shown, forms a kinematic motive network used to transmit and distribute energy and torque from the motor organ 3 to each of the four regulating systems 11 such that it is possible to trace the kinematic chain transmitting driving force from the motor organ 3 to each regulating system 11.

The regulating systems 11 can be of any type, and may for example include Swiss or English lever escapements, mono-, bi- or tri-axial tourbillons, detent escapements, cylinder escapements or any type known by those skilled in the art. Each regulating system 11 can be identical to, or different from, the others, and can beat at the same frequency or at a different frequency from the others. In the case of tourbillons, the rotation speed of the individual cages can also be identical to or different from that of the other cages. This makes it possible to obtain an average of the working of several types of regulating systems, and thus to improve the isochronism of the movement.

In the embodiment illustrated in FIG. 1, each of the second and third differential gears 7, 9 directly or indirectly drives a corresponding seconds display device 12, but it is also foreseeable for a single seconds display device 12 to be provided, driven by one of these gears in branch off of the kinematic motive network. For example, said seconds display device 12 may comprise a seconds display organ such as a hand, a disc or the like secured in rotation with a corresponding wheel that meshes directly with a wheel of the corresponding differential gear 7, 9 serving as input 7e, 9e, respectively, or may be driven indirectly by this same wheel via an intermediate wheel. The seconds display organ can perform one revolution in 30 seconds, one, two, three, four or five minutes, or the like.

Said seconds display device 12 is therefore driven by a kinematic link branched off of the kinematic motive network 5, 7, 9, this kinematic link having a power takeoff driven by the respective differential gear 7, 9 but not belonging to this network 5, 7, 9. Furthermore, the seconds display organ is therefore not secured in rotation with an element forming this network 5, 7, 9. Consequently, a minimum of torque and energy is transmitted by this kinematic link to the seconds display device 12, since the latter is not in the kinematic motive network supplying energy to the regulating systems 11. The seconds display organ, and the wheel associated therewith, can consequently be built to be relatively thin, since the torque to which it is subjected is minimized. Consequently, its construction is not required to be very strong.

By dividing the driving of the display devices 6, 12 between the first differential gear 5 and the subordinate differential gear(s), the rotation speed of the elements of the first differential gear can be relatively slow, in order to be able to transmit a maximum torque to the other two differential gears 7, 9, and at the same time to be able to drive the minutes and hours display device 6. Indeed, if desired, a wheel of the first differential gear 5, for example the wheel serving as input 5e, can be arranged to serve as the typical minutes wheel, thereby limiting the number of intermediate wheels in the kinematic chain. In the case of a different rotation speed, intermediate transmission wheels can of course be provided.

Furthermore, the second and third differential gears 7, 9 can rotate more quickly than the first differential gear 5, which makes it possible to optimize the transmission of energy and torque to the regulating systems as well as to the display devices.

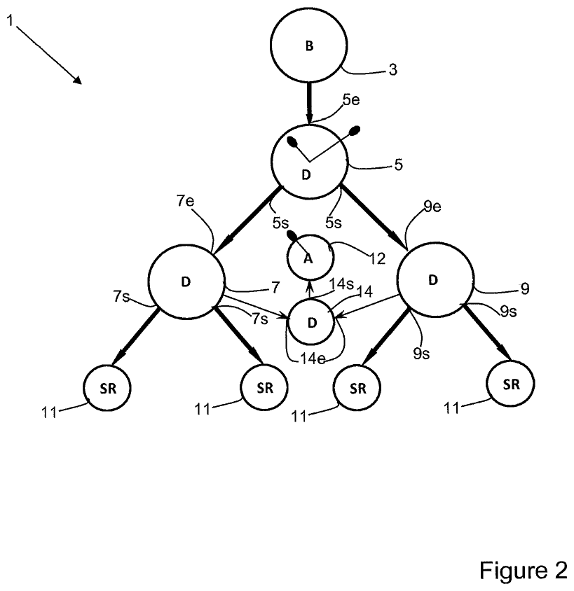

FIG. 2 illustrates a second embodiment of a timepiece movement according to the invention. This alternative differs from that of FIG. 1 in that the seconds display device 12 is driven by the second and third differential gears 7, 9 via a fourth differential gear 14, which comprises two inputs 14e, each being driven by a kinematic link branched off of the kinematic motive network 5, 7, 9, i.e., directly or indirectly from a wheel belonging to the second and third differential gears 7, 9 respectively (for example, the wheel serving as input 7e, 9e). Its output 14s is kinematically linked with a seconds display device 12, which can for example be a hand or a disc secured in rotation with said output 12s, or driven indirectly by the latter. Alternatively, the seconds display device 12 can be integrated in the fourth differential gear 14, while being an index or a marking provided, for example, on the output 12s of this fourth differential gear 14, visible to the user.

The indication of the seconds is consequently determined as a function of the average of the running of the four regulating systems 11.

Furthermore, this configuration has more possibilities in terms of possible choices for the rotation speed of the regulating systems as well as the wheels of the various differential gears 5, 7, 9, since the fourth differential gear 14 can be configured in order to have a reduction or multiplication at its output 14s relative to the rotation speeds of the inputs 14e, without requiring additional wheels.

1.-7. (canceled)

8. A timepiece movement comprising:
at least one motor organ;
four regulating systems, each being kinematically connected with said motor organ via a kinematic motive network arranged to transmit energy from the motor organ to each of said regulating systems;
wherein said kinematic motive network comprises:
a first differential gear having an input kinematically linked with the motor organ and having two outputs;
a second and third differential gear each having an input kinematically linked with a respective output of the first differential gear and each having two outputs, each of the latter outputs being kinematically linked with a respective regulating system;
said movement further comprising:
a device for displaying hours and minutes arranged to be driven by the first differential gear;
at least one device for displaying seconds arranged to be driven by at least one of the second and third differential gears via a kinematic link branched off of said kinematic motive network, said device for displaying seconds comprising a seconds display organ secured in rotation with a wheel that meshes directly or indirectly with the wheel comprised by said kinematic motive network.

9. The movement according to claim 8, wherein the device for displaying hours and minutes is arranged to be driven directly by an element of the first differential gear.

10. The movement according to claim 8, wherein the device for displaying seconds comprises an organ for indicating seconds arranged to be driven by an element of one of the second and third differential gears.

11. The movement according to claim 10, comprising two devices for displaying seconds, one of which is arranged to be driven by an element of the second differential gear, the other of which is arranged to be driven by an element of the third differential gear.

12. The movement according to claim 10, wherein the device for displaying seconds is arranged to be driven by each of the second and third differential gears via a fourth differential gear.

13. The movement according to claim 12, wherein the device for displaying seconds is integrated into said fourth differential gear or is secured in rotation with one of its elements.

14. The movement according to claim 8, wherein at least one of said differential gears comprises a constant force system.
